(19) United States
(12) Patent Application Publication
(10) Pub. No.: US 2004/0139403 A1
(43) Pub. Date: Jul. 15, 2004

(54) Method and apparatus for detecting an edge of a print substrate

(76) Inventors: Igor Yakubov, Herzelia (IL); Yosi Kaplan, Rishon Lezion (IL); Rafael Bronstein, Kfar Saba (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/737,814

(22) Filed: Dec. 18, 2003

Related U.S. Application Data
(60) Provisional application No. 60/434,272, filed on Dec. 19, 2002.

(51) Int. Cl. G06F 17/21

(52) U.S. Cl. 715/527

(57) ABSTRACT

A method and apparatus to detect an edge of a print substrate is provided. The method includes determining the position of an edge of a substrate relative to a reference position on the work surface during loading of the substrate onto the work surface and modifying digital data of an image during printing such that the image is printed on the substrate at a predetermined position relative to the position of the edge.

### CROSS REFERENCE TO OTHER APPLICATIONS

The present patent application claims priority from U.S. provisional patent application 60/434,272, filed Dec. 19, 2002.

### BACKGROUND OF THE INVENTION

The present invention relates to digital printing. In digital printing, knowledge of the accurate position of the print substrate on the work surface is a prime factor to the quality of the print. In particular, when two or more images are printed on a single substrate or when images are printed on a plurality of substrates loaded onto the work surface of the printing system. In backlit displays, an image is printed on a first side of a print substrate, and then the printed substrate is unloaded from the work surface to be reloaded with the printed side of the substrate facing the work surface. A second image, which is a mirror image overlaying the first image is then printed on the second surface. There is a need in the art to provide a method of printing that maintains high-precision registration between the two images without affecting the throughput.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of an exemplary substrate and work surface helpful in understanding embodiments of the present invention;

FIG. 2 is a block diagram of a printing system according to some embodiments of the present invention;

FIG. 3 shows a substrate on a work surface of a printing system according to some embodiments of the present invention;

FIG. 4 is flowchart diagram of a method of detecting an edge of a print substrate during loading according to some embodiments of the present invention;

FIGS. 5 and 6 are schematic illustrations of a backlit display printing application according to some embodiments of the present invention;

FIGS. 7 and 8 shows schematic illustrations of a backlit display printing application according to some embodiments of the present invention;

FIG. 9 shows a plurality of substrates placed on a substrate holding unit; and

FIG. 10 is a flowchart diagram for a method of printing a plurality of images on a plurality of substrates placed on a substrate-holding unit according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE EMBODIMENTS

In the following detailed description, numerous specific details are set forth in order to provide a thorough understanding of the invention. However, it will be understood by those of ordinary skill in the art that the present invention may be practiced without these specific details. In other instances, well-known methods, procedures, formulation and compositions have not been described in detail so as not to obscure the present invention.

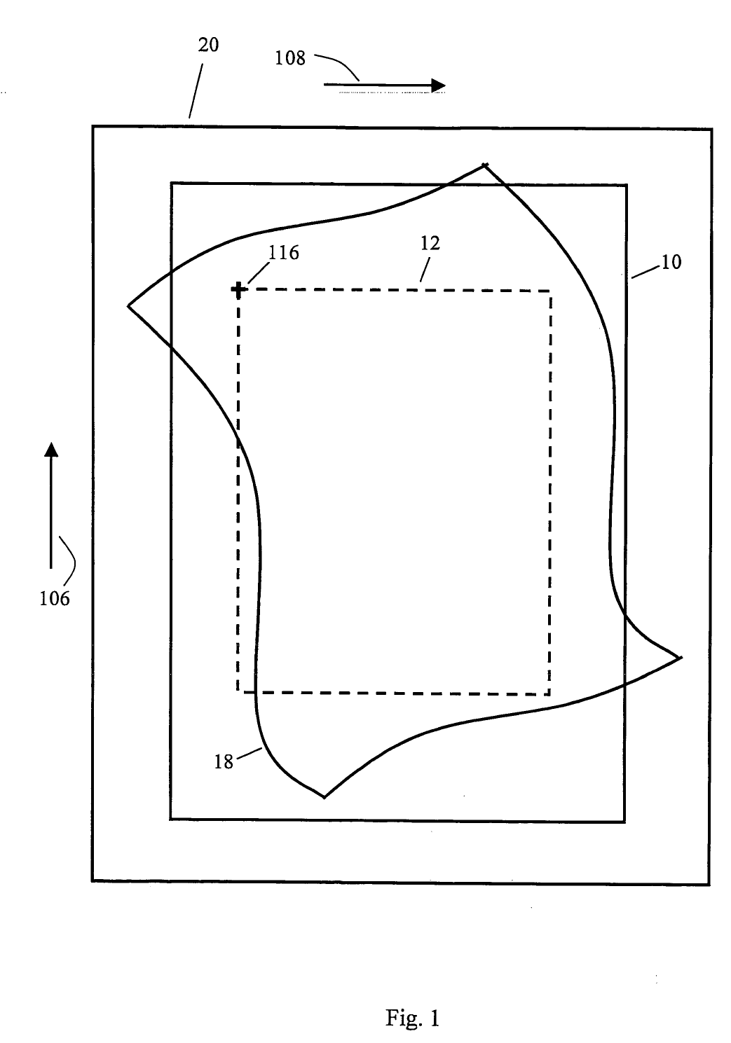

FIG. 1 is a schematic illustration of an exemplary print substrate and work surface helpful in understanding embodiments of the present invention. The work surface may be the surface of a flatbed, a rotating drum or any other work surface known in the art of printing. FIG. 1 shows the ideal position of a rectangular printing sheet 10 on a working surface 20. The edges of the printing sheet are parallel to the edges of the working surface. Dashed rectangle 12 represent the possible print area on substrate 10.

During operation, the print head (not shown) may move in the X direction as indicated by arrow 108, and the substrate may move in the Y direction as indicated by arrow 106. The relative positions of the print head, the substrate and the work surface are determined within a set of coordinates X, Y having their origin at point 116 on work surface 20. Printing begins when the print head is situated at a predetermined position relative to the work surface facing point of origin 116.

When the position of substrate 10 relative to the work surface 20 is at a predefined theoretical position, the printed image is positioned precisely at the desired predefined area on substrate 10 within rectangle 12. In practice, a printing sheet 18, in particular a flexible printing sheet is not a perfect rectangular and during loading it may be skewed. Therefore, the printed image may be deformed or moved from the desired position and orientation.

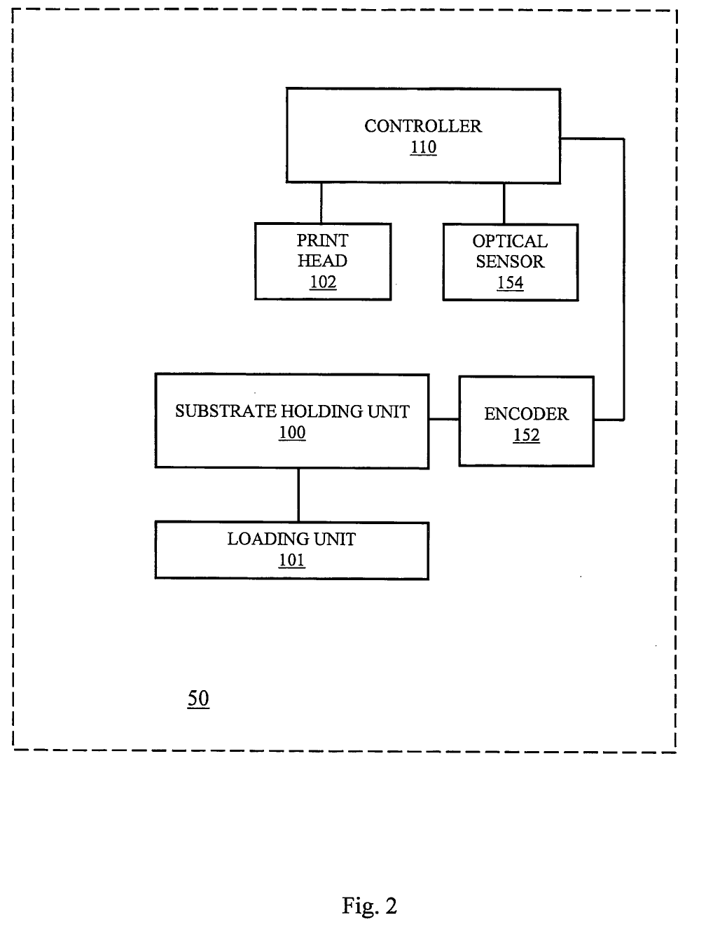

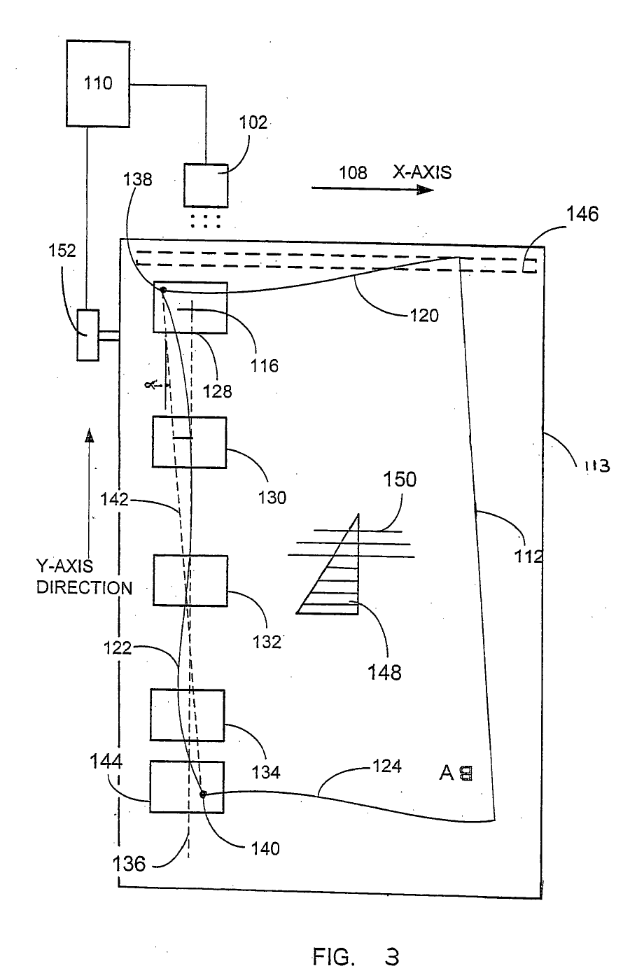

Reference is now made to FIG. 2, which is a schematic block diagram of an exemplary printing system according to some embodiments of the present invention and to FIG. 3, which shows a substrate on a work surface of a printing system according to some embodiments of the present invention. A printing system 50 may comprise a substrate-holding unit 100, such as a rotating drum or flatbed to hold substrate 112 on a work surface 113 and a loading unit 101 to load substrate 112 onto work surface 113. Substrate 112 may be a flexible substrate such as vinyl or a rigid substrate such as a sheet of acrylic material. Substrate 112 may optionally be in a roll form or pre-cut to a certain size sheet form or a rigid plate. For backlit and billboard printing applications, substrate 112 may have large sizes, for example, two by three meters or more, and as shown in FIG. 3 may have uneven wavy edges 120, 122, and 124.

System 50 may further comprise an inkjet print head 102 and a controller 110 coupled to print head 102 and to substrate holding unit 100. According to some embodiments of the present invention, system 50 may comprise an encoder 152 and an optical sensor, such as a video camera 154 in synchronization with encoder 152, both coupled to controller 110. Alternatively, the optical sensor may be a linear CCD array or any other optical sensor known in the art. Encoder 152 may provide the Y coordinate of the position of a point on edge 122 of substrate 112 relative to the point of origin 116.

Video camera 154 may provide input to controller 110 for calculating the X coordinate of the position of that point relative to the point of origin 116. The video camera 154 may be positioned with its field of view facing the work surface. It should be understood to the man skilled in the art that an initial calibration might be required so that the line of sight of the camera crosses through a point with known coordinates, such as the point of origin 116. The calibration process may be any suitable calibration known in the art.

Back to FIG. 3, rectangles 128, 130, 132, 134 and 140 represent the area covered by frames of the video camera at different times during loading of the substrate onto the work surface 113. Dashed line 136 parallel to the Y-axis is a virtual reference line representing the geometrical positions of virtual points reflected at the center of consequent frames. Dashed line 142 positioned at an angle α relative to the Y-axis is a virtual line connecting corner 138 at a first end of edge 122 and corner 140 at a second edge of edge 122.

For an even smooth edge, data received from two frames as to the position of two points on edge 122 relative to the origin point 116 may be sufficient in order to calculate the angle α. In order to define more accurately the position of points on wavy edge 122 relative to the point of origin 116, a plurality of grabbed frames 130, 132, and 134 may be required. The number of grabbed frames required for accurate definition of the position of edge 122 is a function of the accuracy desired and length of substrate 112.

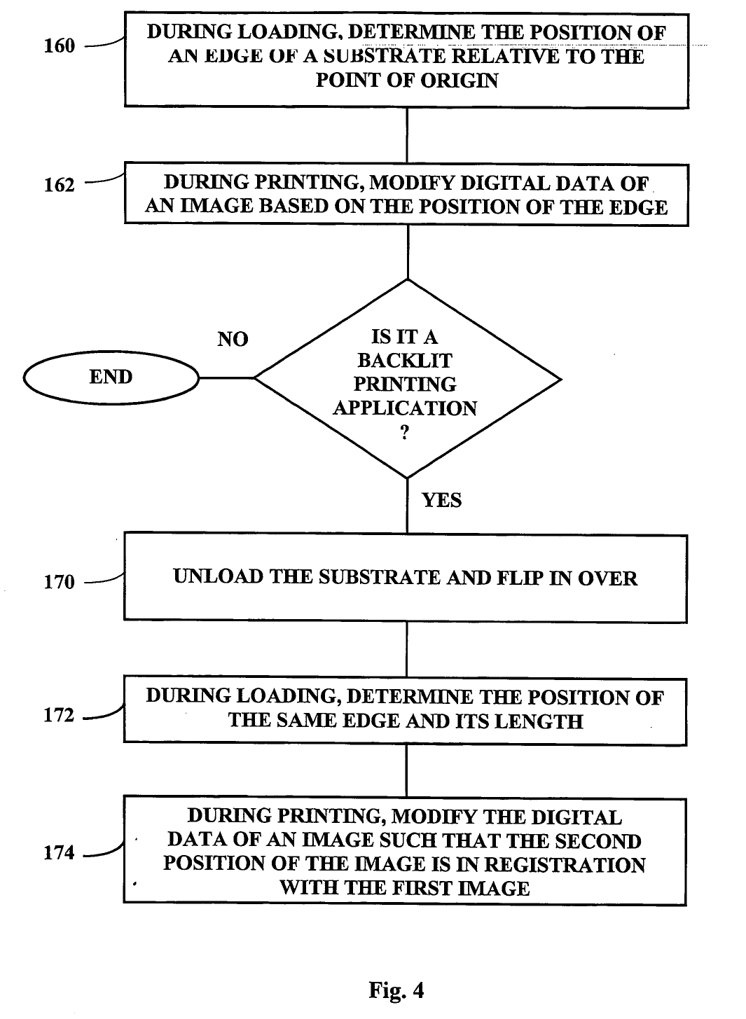

Reference is additionally made to FIG. 4, which is a flowchart diagram of a method of detecting an edge of a print substrate during loading according to some embodiments of the present invention. The exemplary embodiments described below refer to backlit display applications, however it should be understood to a man skilled in the art that it does not limit the scope of the invention and that embodiments of the invention may be implemented in other printing applications.

Throughout the specification and the claims, the term “column” refers to pixels that belong to the same line parallel to the Y-axis and the term “line” refers to pixels that belong to the same line parallel to the X-axis.

As described at block 160, during loading of substrate 112 on to work surface 113, video camera 154 may capture frame 128, which includes the point of origin 116 and top corner 138 and one or more consequent frames 130, 132 and 134. Encoder 152 may send its read-outs to controller 110, which may generate and may store in a memory (not shown) pairs of X, Y coordinates for a plurality of points. Controller 110 may determine points on virtual lines 136 and 142. Optionally, video camera 154 may capture frame 144, which includes bottom corner 140. The difference between the Y coordinates of corners 138 and 140 may then be calculated. Knowledge of that value is required for registration of the image on the other side of the substrate as will be explained below. However, for accurate positioning of an image at a desirable position on a first side of the substrate, there is no need to know the accurate position of corner 140 or the length of the substrate.

As described at block 162, an image 148 is printed on a first side “A” of substrate 112. Controller 110 may determine the size of the shifts in the X direction and in the Y direction for a portion of the image data and in real-time may modify the image data accordingly. The modified data is delivered on real-time to the print head such that the speed of printing is not affected by the concurrent data modification operation.

For example, controller 110 may determine during printing the shift in the direction of X-axis for every printed line 150. A simplified calculation of the shift in the X direction for a plurality of lines involving averaging shifts based on positions of the two captured image frames may be sufficient for the required accuracy. A similar set of calculations defining the average shift in Y-direction may be performed for the printed columns.

It is well known that the ink layer changes its thickness and linear dimensions during drying and to some extent during curing, which causes changes in the dimension of the printed substrate. The extent of the change depends on the size of the printed image and ink load, and for large backlit displays may be as large as a few millimeters.

Image 148 may be the image facing the backlit light source. According to some embodiments of the present invention, image 148 facing the backlit light source may be printed at half ink load. Printing an image at a partial ink load may diminish the changes in the dimensions of the printed image and substrate. The ink load may be predetermined based on the ink density required for a specific backlit application.

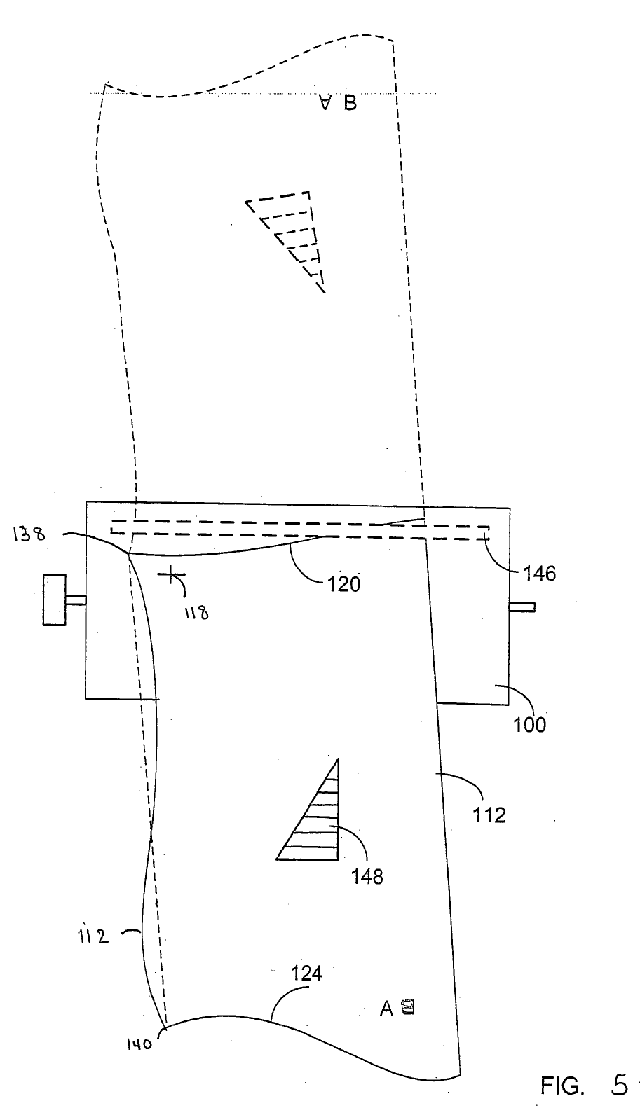

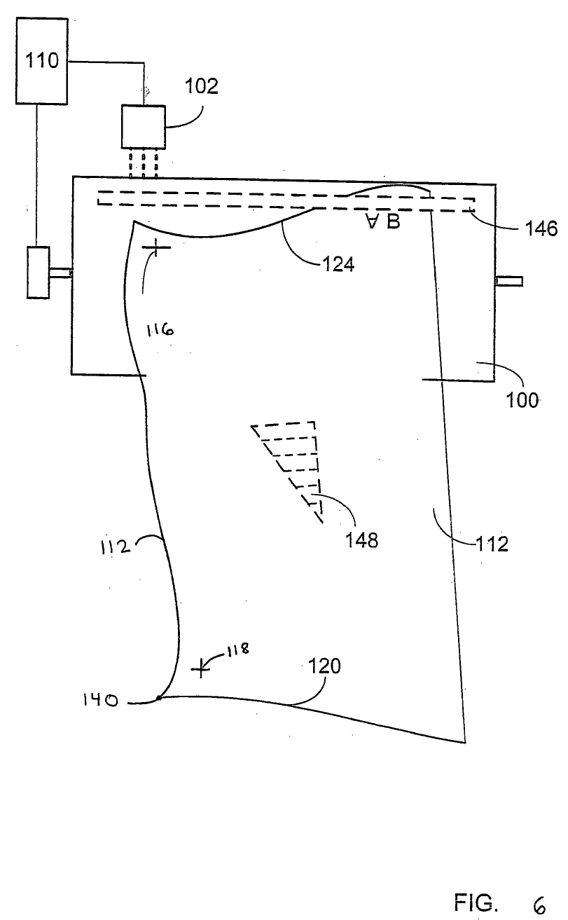

Referring now to FIGS. 5 and 6, the cross on substrate 112 represent a registration point 118, which is the point on side A of substrate 112 that coincided with point of origin 116 when image 148 has been printed. When the ink is dry, a gripper 146 may release the gripped edge 120 of substrate 112. Substrate 112 may then be flipped over edge 120 and reloaded such that gripper 146 holds the opposite edge 124 and side B of substrate 112 is facing print head 102 (block 170). As a result of the flip-over operation, registration point 118 is not positioned in the vicinity of gripper 146 and point of origin 116. The position of the substrate relative to the point of origin 116 has to be re-determined in order to print the second image on side B in registration with the first image printed on side A.

In order to determine the shift in the Y direction of the image data, the distance between the gripper and the opposite edge 120 may be determined upon loading. If the length of substrate 112 in the Y direction is not sufficient to accommodate the image, printing may be aborted.

Determining the shift in the Y direction may be further complicated due to changes in the dimension of the substrate and the printed image. Similar to the operation of loading described at block 160, during reloading of substrate 112, video camera 154 may capture two or more frames along edge 122, and at least the frames that include corners 138 and 140 of edge 122 and together with the input received from encoder 152 the distance between corner 140 and the opposite corner 138 may be determined. Also, the angle α, which is the angle at which a virtual line connecting corners 138 and 140 of edge 122 is skewed relative to the Y-axis may be determined (block 172). Knowledge of the position of edge 122 relative to origin 116 as determined during the first loading of substrate 112 (block 160) and the value of angle α and the distance between the corners of edge 122 as determined during the second loading may enable to determine the required shifts of the second image data to acquire registration between the first image on side A of substrate 112 and the second image on side B of substrate 112.

Controller 110 may determine the required image shift in both the X and Y directions to compensate digitally for changes in the size and relative position of the image. The modified image data ensures that the second image printed on side B of substrate 112 is in registration with the first image 148 printed on side A of substrate 112. Similar to the printing operation on the first side A of substrate 112, controller 110, may determine the shift in the X direction for each line in real-time during printing. Similarly, controller 110 may determine the shift in the Y direction for every column.

During the printing process (on-line) controller 110 may rearrange the image data in a way that the image printed on the second side “B” of substrate 112 coincides with image 148 printed on the first side “A” of substrate 112 (block 174). The image data is not rotated or skewed. Rearrangement of the data by shifting rows or columns in the required direction is advantageous to data rotation or skewing since it requires significantly less computing power. It may be performed in course of the printing on-line in real time and accordingly may reduce the cost of the printing system and increase its throughput.

Although the present exemplary embodiment of backlit display printing has been demonstrated by printing of a single image on a substrate, it is clear that the same method may be applied for printing a plurality of images on the same substrate.

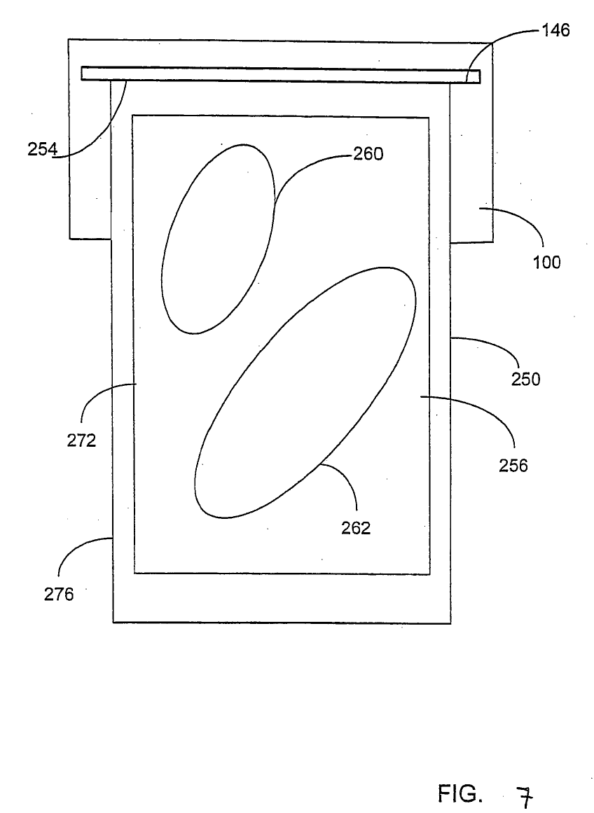

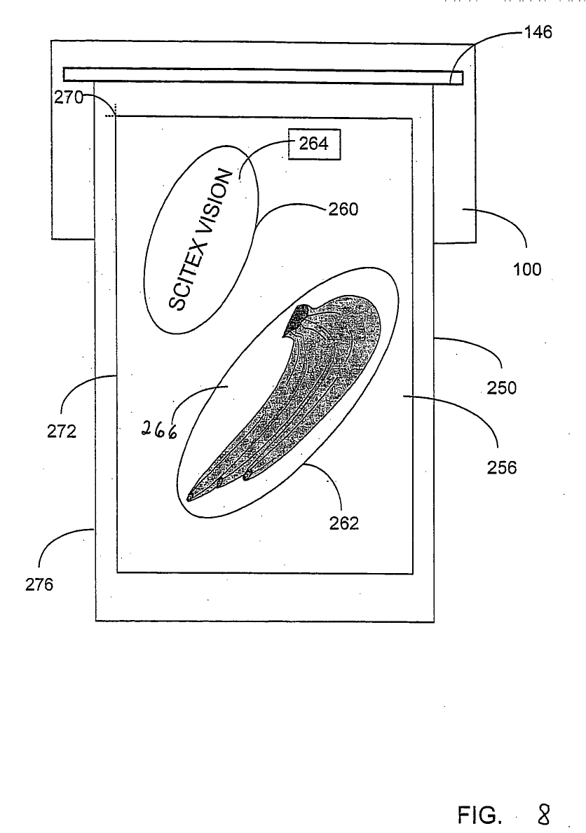

An additional exemplary embodiment discloses a method of digital printing of a plurality of images on a single substrate. FIG. 7 shows a substrate 250, which is a transparent or semi-transparent backlit display, loaded onto drum 100 of an ink jet printer. Gripper 146 may hold a forward edge 254 of substrate 250. A background image 256 may be pre-printed on substrate 250 such that locations 260 and 262 remain blank. Alternatively, a different background, for example white background may be pre-printed on locations 260 and 262. Then, images 264 and 266 may be printed on locations 260 and 262. The coordinates of locations 260 and 266 relative to the point of origin 270 may be known.

Typically, background image 256 is printed on a screen-printing machine having a registration pin system. Variable information that is added to background image 256 should be in registration with left for it image locations 260 and 262. In order of adding to background image 256 specific variable information 264 and 266 to be printed on locations 260 and 262 a similar pin registration system should exist on the ink jet printer.

In accordance with the additional exemplary embodiment, substrate 250 is loaded on drum 100. According to some embodiments of the present invention, the method described above in respect to FIG. 4 may be applied for the detection of the position of the background point of origin and the angle of edge 272 relative to the Y-axis. Alternatively, the same method may be applied to detect the position relative to a reference position of an edge 276 of substrate 250. The data of images 264 and 266 containing specific variable information to be printed on locations 260 and 262 may then be corrected before or during printing.

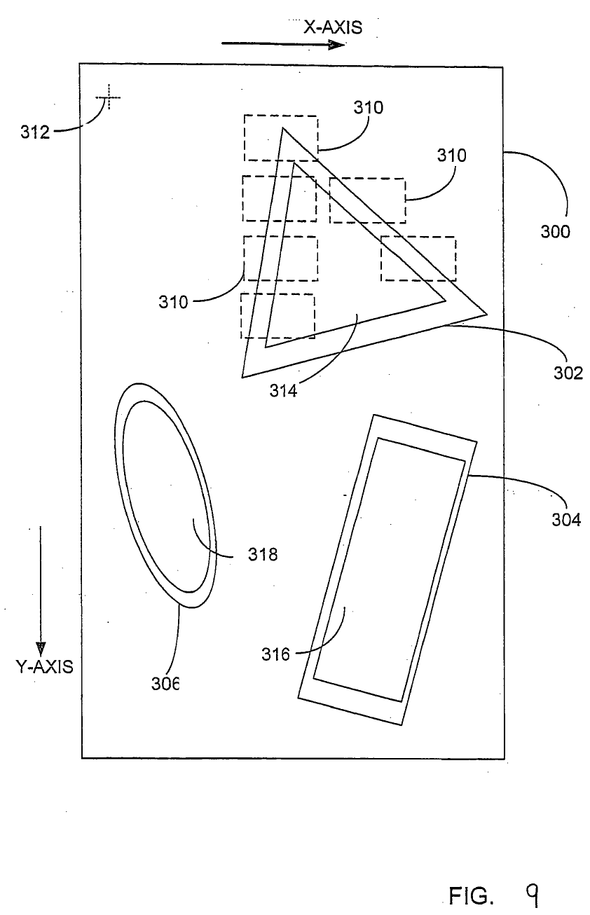

A further exemplary embodiment discloses a method of digital printing of a plurality of images on a plurality of substrates placed on a single substrate-holding unit. FIG. 9 illustrates a substrate holding article, for example, a flat table 300 having a plurality of substrates 302, 304, and 306 placed on it in arbitrary positions. Substrates 302, 304, and 306 may have any arbitrary form, size and/or texture.

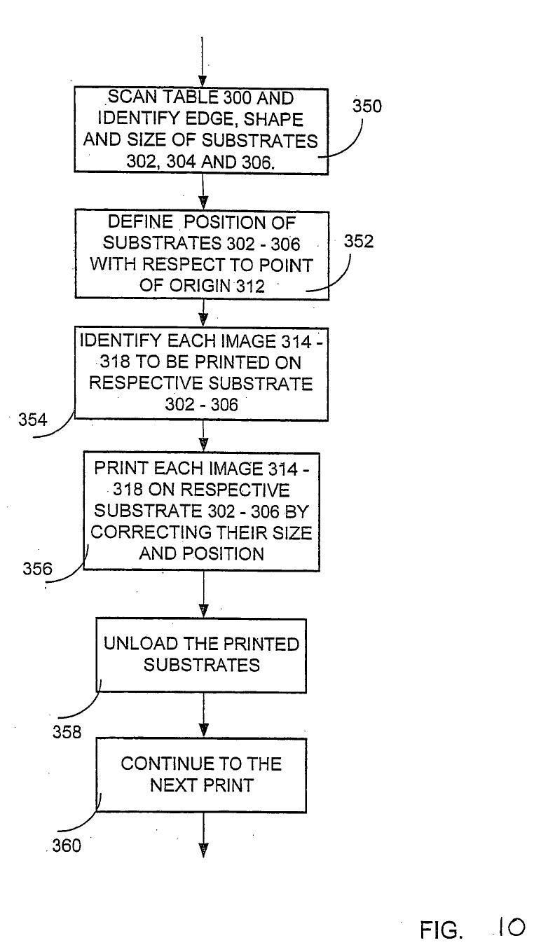

FIG. 10 is a flow chart diagram illustrating the printing process of a plurality of images on a plurality of substrates placed on a single substrate-holding article. According to an exemplary embodiment of the present invention, before printing on substrates 302, 304, and 306 an optical sensor, such as video camera 154 may scan table 300 and may capture images of substrates 302, 304, and 306 (block 350). A number of exemplary frames captured by the video camera are illustrated as rectangles 310. The video camera may provide the captured data to controller 110. Controller 110 may process the scanned data to identify the edges, the shape, and the dimensions of each of the substrates 302, 304, and 306.

As described at block 352, controller may define the position of substrates 302, 304, and 306 on table 300 relative to reference point 312. Controller 110 may identify digital data of images 314, 316, and 318 to be printed on each of substrates 302, 304, and 306 (block 354). The digital data of images 310, 312, and 314 may be stored in a memory within controller 110 or alternatively at another storage.

Alternatively, other edge detection methods known in the art may be used for defining the relative position of substrates 302, 304, and 306 on table 300 with respect to a reference point.

At block 356, controller 110 may start printing and simultaneously may adapt the data of images 314, 316, and 318 to match the size and location of substrates 302, 304, and 306. At block 358 the printed substrates 302, 304, and 306 may be unloaded from table 300 and at block 360 the process continues to the next print.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
during loading of a substrate onto a work surface, determining position of an edge of said substrate relative to a reference position on the work surface; and
during printing, modifying digital data of an image such that the image is printed on said substrate at a predetermined position relative to the position of said edge.

2. A method comprising:
during loading of a substrate onto a work surface, determining first position of an edge of said substrate relative to a reference position on the work surface; and
during printing, modifying digital data of a first image such that the first image is printed on a first surface of said substrate at a predetermined position relative to the position of said edge.

3. The method of claim 1 comprising:
during reloading of said substrate onto said work surface, determining a second position of said edge relative to said reference position; and
during printing, modifying digital data of a second image such that the second image is printed on a second surface of said substrate overlaying said first image.

4. The method of claim 3, wherein the first image is printed at a partial ink load.

5. The method of claim 4, wherein the second image is printed at a full ink load.

6. A method comprising
determining positions of edges of substrates placed on a work surface relative to a reference position on the work surface; and
during printing, modifying digital data of images, such that each of said images is printed on one of said substrates at a predetermined position relative to the positions of said edges.

7. The method of claim 6 wherein at least two of said substrates have different sizes.

8. The method of claim 6 wherein at least two of said substrates have different texture.

9. A printing system comprising:
an optical sensor to send digital orientation of an edge of a substrate loaded onto a work surface;
a controller to determine the position of said edge relative to a reference position on the work surface and to modify digital data of an image such that the image is printed on said substrate at a predetermined position relative to the position of said edge; and
a print head to print said substrate.
